(19) United States
(12) Patent Application Publication
(10) Pub. No.: US 2015/0007498 A1
(43) Pub. Date: Jan. 8, 2015

(54) HYDROPONIC SYSTEM

(71) Applicant: Joshua Hensley, Port Orford, OR (US)

(72) Inventor: Joshua Hensley, Port Orford, OR (US)

(21) Appl. No.: 14/321,777

(22) Filed: Jul. 1, 2014

Related U.S. Application Data
(60) Provisional application No. 61/481,443, filed on May 2, 2011.

(51) Int. Cl. A01G 31/02

(52) U.S. Cl. CPC A01G 31/02
USPC 47/62 R

(57) ABSTRACT

A self contained hydroponic system is provided comprising a large reservoir, a small media pot contained within the larger reservoir, a submerged water pump, an air pump, and a T-shaped manifold for transferring water to the media in the media pot.

### CLAIM OF PRIORITY

This patent application claims priority under 35 USC 119 (e) (1) from U.S. Provisional Patent Application Ser. No. 61/841,443 filed Jul. 1, 2013, of common inventorship herewith entitled, “Hydroponic System.”

### BACKGROUND OF THE INVENTION

1. Field of the Invention

This invention relates generally to a hydroponic system and, more particularly, the invention relates to a hydroponic system providing a self-contained hydroponic system for growing a myriad of vegetables and plants and adaptable for both general household and professional farming use.

2. Description of the Prior Art

A versatile and efficient means of growing plants is through hydroponic methods. Hydroponics is a process of cultivating plants without the use of soil, with the soil replaced by a medium such as gravel, coconut husk or even mineral wool. With hydroponics, the plants are nourished by water and mineral rich solutions that allow the plant to flourish in a soil-free environment. The benefits of growing plants using hydroponic methods are plentiful, particularly in areas where ground soil is contaminated or not conducive to plant life. Further, hydroponics can be implemented indoors in areas where the natural climate does not allow for normal plant production. Without the use of soil, plants that are grown hydroponically can take up a fraction of the space associated with plants grown in fields, gardens and beds and because no soil is involved, the gardener can enjoy significantly greater control over the nutrient levels of the plants as they are grown and harvested. Further, the water utilized in hydroponics is recycled through the system and reused, thus saving money by reducing water costs. Finally, plants that are grown hydroponically are cultivated in a controlled environment, thus eliminating the pollution associated with harvesting plants through traditional methods, while also ensuring high and stable crop yields.

### BRIEF DESCRIPTION OF THE DRAWINGS

FIG. 1 is a front perspective view illustrating a hydroponic system, showing the lid of a four gallon square media pod, flow feed tubes, cut in lid, thirteen gallon rectangular reservoir, three quarter inch black vinyl tubing with elbow for easy drainability and water exchange.

FIG. 2 is top perspective view showing the device of the present invention, showing the five point flow feed system, water pump hole and air pump hold for outlet cards and water pump hole for insertion of water.

FIG. 3 is a front perspective view of the present invention showing a plant in the container and a water inlet pipe which is also shared to connect to other units sharing the same water level.

FIG. 4 is a phantom front perspective view showing internal components and a clip on hook, and black tubing for UV protection and black FPVC tubing sleeve.

FIG. 5 is top down view of the lid of the media pot and showing optional holes and an offset from center cut to allow easy insertion of a plant into the device.

### DETAILED DESCRIPTION OF THE PREFERRED EMBODIMENTS

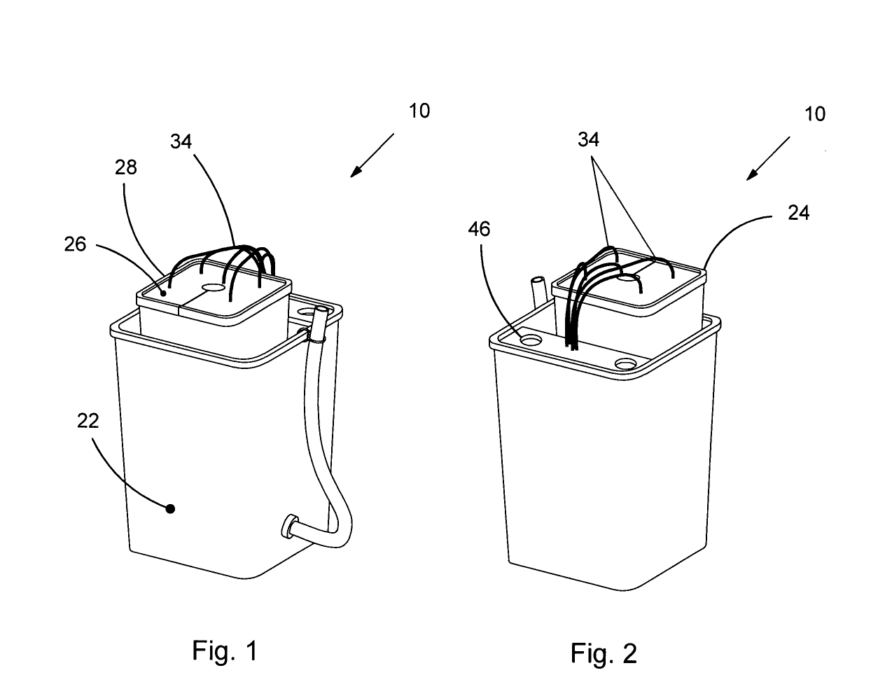

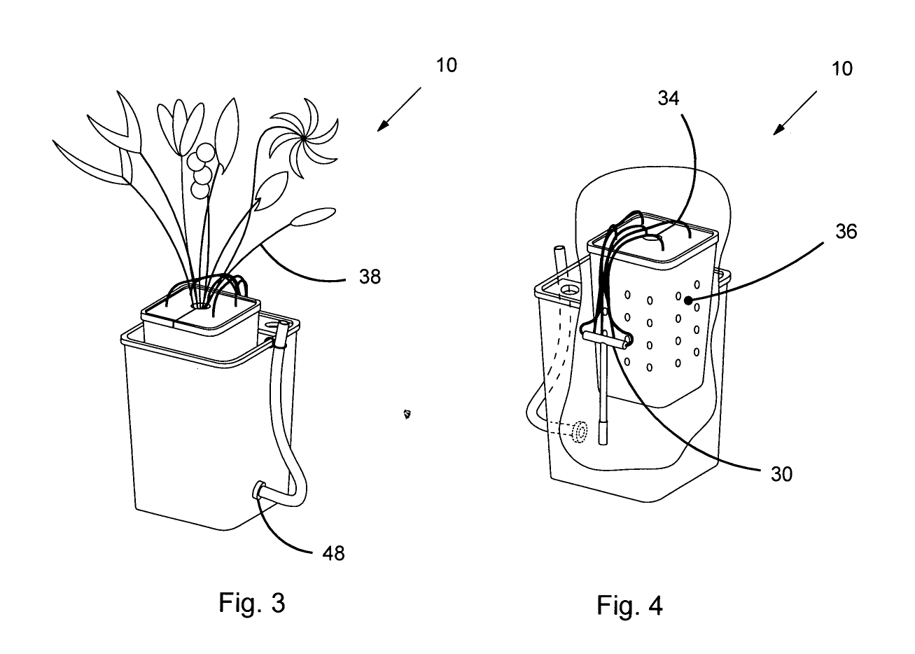

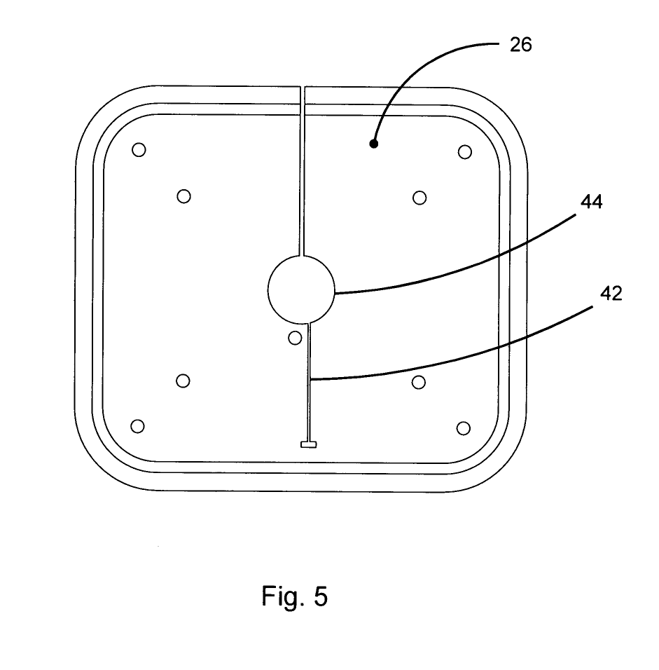

As illustrated in FIGS. 1-5, the present invention is a hydroponic system providing a self-contained hydroponic system for growing a myriad of vegetables and plants and adaptable for both general household and professional farming use.

The hydroponic system of the present invention can be offered in a variety of sizes and configurations to accommodate various needs. For instance, small, stand-alone units can be made available for use in a backyard or patio garden, while industrial size, multi-count units can be made available for institutional and professional use. A standard version of this system, is offered for review. The basic components of the hydroponic system 10 include a heavy duty, rectangular shaped thirteen gallon reservoir 22 and lid 24 assembly, both of which are manufactured of a UV resistant and heavy duty PVC plastic or comparable material; a small, four gallon media pot 26 and media pot lid 28 manufactured of the above mentioned materials; an air and water pump (not shown); a thirteen inch T-shaped manifold 30 for transferring water from the larger reservoir 22 to the media pot 26, wherein the T-shaped manifold is 22 manufactured of heavy duty PVC material: and ¼ inch, ½ inch and ¾ inch plastic flow tubing. The four gallon media pot 26 is perforated to allow roots of plant 38 to grow out of the perforations and into the water in the thirteen gallon reservoir 22. Roots growing into the water in the reservoir 22 constitute “sub-cult”. The water pump is submerged in thirteen gallon reservoir 22 and recirculates the water/nutrient solution. As used herein, the term “water” is defined as water containing nutrients. Optimally, the water is changed periodically to promote maximum growth. In an embodiment, the water is changed weekly.

The hydroponic system of the present invention utilizes a five point, top flow feed system 32 involving sub-cult with the self-contained reservoir 22. The system 10 also utilizes a square grow pot, also referred to as media pot 26. Media pot 26 has a slit 42 in the lid 28 to allow the user to surround the lid 28 of pot 26 around the crown of plant 38. Plant 38 is placed in media pot 26 so that the top of plant 38 extends upward through hole 44 in media pot lid 26. The thirteen gallon rectangular reservoir housing 22 contains a four gallon square media pot 26 through the top. The media 36 contained within media pot 26 is watered from a water pump through a PVC, T-shaped manifold 30 with five, ¼ inch flow feed tubes 34 going out through the lid 24 and are anchored down into the four gallon square media pot 26 with snap on lid 28. The system can be run on a timer, or manually. Water is recirculated from reservoir 22 into four gallon media pot to mimic rainfall by means of five point flow system 32 which comprises T-manifold 30 which feeds into the five feed flow tubes 34.

One embodiment supplies nutrients for fifteen minutes every three hours. In this manner, the designated plant 38 flourishes within the media pot 26, with the water recycled continuously in order to water the plant. An external air pump (not shown) pumps air through air pump hole 46 to aerate the water contained in reservoir 22. Plants are then allowed to flourish and grow within the system until they have reached full maturity, at which point they are harvested. The system can then be replenished with a fresh crop of seedlings or clones and the entire cycle can be repeated indefinitely. Water inlet pipe 48 alllows fresh water to be entered into the system and also permits easy drainage when it is time to change the water.

The hydroponic system of the present invention offers users a number of significant benefits and advantages. Foremost, the system provides a simple and environmentally friendly means of growing vegetables, herbs, flowers and a plethora of other types of plants, without the use of soil. A portable, hydroponic system, the system takes up a fraction of the space associated with planting fields, gardens or plant beds. Aided by the nutrient rich water supply and planted within a square shaped media bucket, plants flourish within the system, growing strong roots and abundant foliage in a manner that is significantly quicker than traditional planting methods. Extremely versatile, the system can be utilized to cultivate any number of nutritious vegetables, fragrant flowers, medicinal botanicals and delectable herbs and spices, providing efficient mass production of a variety of plants in a limited space. Further, because plants grow significantly faster in the system, crops are replenished quickly, thus affording greater yields and more abundant harvests. Ideal for use by those who have limited space and still like the benefits of planting a garden, the system is well-suited for use by general household users including homeowners, apartment dwellers and those who live in condominiums or mobile homes. Enabling users to enjoy delicious, organic vegetables, herbs and spices that they themselves have planted and harvested, use of the system can also significantly reduce grocery bills. Well-suited for general user use, the system can also be employed by professional farmers, providing these hardworking individuals a simple means of expediting the planting process, while simultaneously increasing crop production. Environmentally friendly, the system reduces water costs associated with planting in soil, as well as eliminate the pollution associated with other planting methods.

The hydroponic system of the present invention provides users an effective means of growing a myriad of vegetables and plants. A hydroponic system that can be utilized in confined spaces, both indoors and out, the system serves a myriad of practical applications.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

1. A self-contained hydroponic system comprising: a heavy duty, large reservoir and lid capable of containing water; a small media pot and media pot lid; wherein the small media pot is placed inside and the large reservoir, wherein the lid of the large reservoir accommodates the small media pot; and further comprising
an air pump and water pump; a T-shaped manifold for transferring water from the reservoir into the media pot; plastic flow tubing, wherein the small media pot is perforated to allow roots of a plant to grow out of the perforations and into water in the large reservoir, wherein the water pump is submerged in the large reservoir to recirculate water; further comprising a top flow feed system, wherein the top flow feed system comprises media contained within the small media pot watered from the water pump through T-shaped manifold with flow feed tubes, which feed tubes extend out through the lid of the large reservoir and are anchored down into the small media pot.

2. The hydroponic system of claim 1, wherein the large reservoir and small media pot are manufactured of UV resistant and heavy duty PVC plastic or comparable material

3. The hydroponic system of claim 1, wherein T-shaped manifold are manufactured of heavy duty PVC material.

4. The hydroponic system of claim 1, wherein the large reservoir is approximately thirteen gallons.

5. The hydroponic system of claim 1, wherein the small media pot is approximately four gallons.

6. The hydroponic system of claim 1, wherein the large reservoir is rectangular.

7. The hydroponic system of claim 1, wherein the top flow system has five feed tubes.

8. The hydroponic system of claim 7, wherein the feed tubes are one quarter inch diameter.

9. The hydroponic system of claim 1, wherein the small media pot has a slit in the lid to allow a user to surround the lid of the pot around the crown of a plant.

10. The hydroponic system of claim 1, wherein the air pump is external to the system and pumps air through an air pump hole in the large reservoir to aerate the water contained in the large reservoir.

11. The hydroponic system of claim 1, further comprising a water inlet pipe capable of receiving fresh water and also permitting easy drainage for changing the water.
